(19) United States
(12) Patent Application Publication
(10) Pub. No.: US 2012/0151545 A1
(43) Pub. Date: Jun. 14, 2012

(54) MULTIMEDIA SYSTEM, METHOD FOR DISPLAYING MULTIMEDIA CONTENT AND COMPUTER READABLE STORAGE MEDIUM FOR STORING THEREOF

(75) Inventors: Chih-Hao Hsu, Taipei City (TW); Chang-Gang Chen, Hsinchu City (TW); Chang-Jen Tu, Taipei City (TW); Cheng-Fu Chou, Taipei City (TW); Chun-Wei Chen, Dashu Town (TW); Yeu-Chern Harn, Taipei City (TW)

(73) Assignee: Institute for Information Industry, Taipei (TW)

(21) Appl. No.: 13/112,616

(22) Filed: May 20, 2011

(30) Foreign Application Priority Data
Dec. 10, 2010 (TW) 99143282

(51) Int. Cl. H04N 7/173

(52) U.S. Cl. 725/115

(57) ABSTRACT

A method for displaying multimedia content includes the following steps: at least one front node captures at least one present image. The front node includes a photographic unit and a display unit. At least one middle node receives the at least one present image and filters the present image to obtain at least one characteristic block. The at least one middle node transmits the at least one characteristic block to at least one end node. The at least one end node stores several candidate multimedia contents. The at least one end node selects at least one multimedia content proposed to be displayed corresponding to the characteristic block, from the candidate multimedia contents. The at least one multimedia content proposed to be displayed is responded to the at least one front node passing through the at least one middle node. The display unit displays the at least one multimedia content.

### RELATED APPLICATIONS

This application claims priority to Taiwan Application Ser. No. 099143282, filed Dec. 10, 2010, which is herein incorporated by reference.

### BACKGROUND

1. Technical Field

The present invention relates to a multimedia system, a method for displaying multimedia content and a computer readable storage medium for storing thereof.

2. Description of Related Art

Nowadays, multimedia is applied to many fields, such as education, entertainment, advertisement and so on. The bulletins for non-specific persons can be taken as advertisements, such as public welfare advertisements, travel advertisements, commercial advertisements etc. Advertisement is a form of communication intended to persuade an audience (viewers, readers or listeners) to purchase or take some action upon products, ideas, or services. Commercial advertisement is often used to seek to generate increased consumption of their products or services through branding, which involves the repetition of an image or product name in an effort to associate related qualities with the brand in the minds of consumers.

In general, a specific target may be set for education, entertainment or advertisement, such as a specific group of people. In other words, if multimedia, which is designed for education, entertainment or advertisement, is played to the expected persons, best advertisement effects may be obtained; if the multimedia is played to the persons other than the expected ones, advertisement effects may be reduced. Since it costs a lot to show multimedia in public, multimedia providers have to consider how to make multimedia (especially advertisement multimedia) shown with maximal benefits.

In our daily life, there are many different multimedia media, such as light boxes, vehicle bodies, KIOSK information station, all kinds of display units, screen walls, advertisement boards, digital boards etc. When using the above-mentioned media for advertisements, the same content of the advertisement are played repeatedly wherever the media moves to. In addition, although most present advertisement boards or digital bulletins have computer equipments and network connection functions, the content of the advertisement displayed on the above-mentioned media can only display same multimedia contents as scheduled and the displayed multimedia contents can't be changed as environments or passengers differ. Therefore, the effects of the above-mentioned media for education, entertainment or advertisement are not good. Above all, it's an important issue to display suitable multimedia content on medias according to persons who passing through or standing by the medias thereof.

### SUMMARY

According to one embodiment of this invention, a method for displaying multimedia content is provided. In the method for displaying multimedia content, an image captured by a front node is transmitted to a middle node, the middle node filters the received image to obtain at least one characteristic block of the image, the at least one characteristic block is provided to an end node to be a factor to select a multimedia content to be responded. The method for displaying multimedia content includes the following steps: at least one front node captures at least one present image. The front node includes a photographic unit and a display unit. At least one middle node receives the at least one present image and filters the at least one present image to obtain at least one characteristic block of the at least one present image. The at least one middle node transmits the at least one characteristic block to at least one end node. The at least one end node stores several candidate multimedia contents. The at least one end node selects at least one multimedia content proposed to be displayed, which is corresponding to the characteristic block, from the candidate multimedia contents. The at least one multimedia content proposed to be displayed is responded to the at least one front node passing through the at least one middle node. The display unit of the at least one front node displays the at least one multimedia content proposed to be displayed.

According to another embodiment of this invention, a computer readable storage medium with a computer program for an electrical device to execute a method for displaying multimedia content after loaded thereof. The method for displaying multimedia content is mentioned above.

According to another embodiment of this invention, a multimedia system is provided. In the multimedia system, an image captured by a front node is transmitted to a middle node, the middle node filters the received image to obtain at least one characteristic block, the at least one characteristic block is provided to an end node to be a factor to select a multimedia content to be responded. The multimedia system includes at least one front node, at least one end node and at least one middle node. The at least one middle node builds connections with the at least one front node and the at least one end node respectively. The at least one front node includes a photographic unit and a display unit. The at least one end node includes an end-node storage unit for storing several candidate multimedia contents. The at least one middle node includes a middle-node processing unit. The middle-node processing unit includes an image receiving module, an image filtering module, an obtaining module and a responding module. The image receiving module receives at least one present image, which is captured by the photographic unit, from the at least one front node. The image filtering module filters the at least one present image to obtain at least one characteristic block of the at least one present image. The obtaining module transmits the at least one characteristic block of the at least one present image to the at least one end node to obtain at least one multimedia content proposed to be displayed, which is corresponding to the characteristic block of the at least one present image and is selected from the candidate multimedia contents, from the at least one end node. The responding module responds the at least one multimedia content proposed to be displayed to the at least one front node through the at least one middle node. The display unit of the at least one front node displays the at least one multimedia content proposed to be displayed.

Above all, the front node can display the multimedia content corresponding to the present image captured itself. In one embodiment, the multimedia content displayed on the display unit of the front node may correspond to the pedestrian category in the present image captured by the front node. Especially, if the multimedia content displayed on the display unit of the at least one front node is advertisement, the at least one front node may have better advertising effects. The middle node filters the captured image to obtain a characteristic block and only transmits the characteristic block to the end node, which can reduce the size of the transmitted image and reduce the loading of the end node. In addition, since the ability to identify the category in the present image is not necessary for the middle node, the middle node does not have to have better computing ability and hence cost of such middle node is much cheaper than the end node. In other words, a cheaper machine can be utilized as the middle node, which can save the cost.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a method for displaying multimedia content according to one embodiment of this invention; and

FIG. 2 illustrates a block diagram of a multimedia system according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

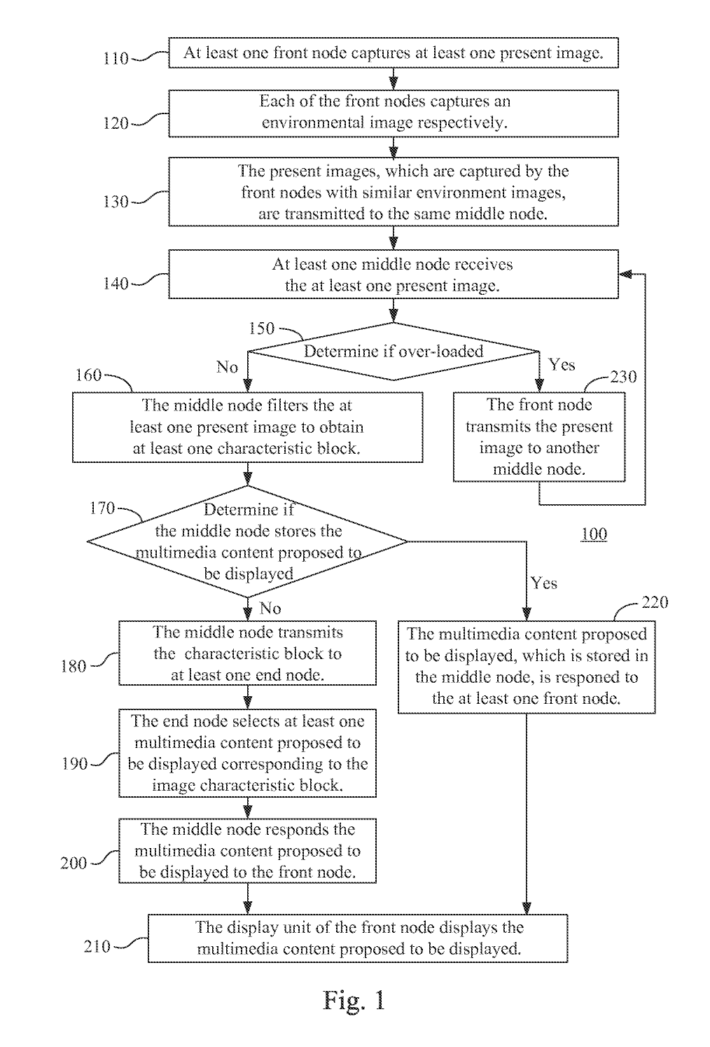

FIG. 1 is a flow diagram of a method for displaying multimedia content according to one embodiment of this invention. In the method for displaying multimedia content, an image captured by a front node is transmitted to a middle node. The middle node filters the received image to obtain at least one characteristic block of the image, and the at least one characteristic block of the image is provided to an end node for selecting a multimedia content to be responded. The method for displaying multimedia content may take the form of a computer program product stored on a computer-readable storage medium having computer-readable instructions embodied in the medium, such that a computer can execute the method for displaying multimedia content after reading the computer-readable storage medium thereof. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The method for displaying multimedia content 100 mainly includes steps 110, 140, 160, 180, 190, 200 and 210. Descriptions of steps of the method for displaying multimedia content 100 are as follows:

In step 110, at least one front node captures at least one present image to transmit to at least one middle node. Wherein, the least one front node includes a photographic unit and a display unit. The at least one present image is captured utilizing the photographic unit of the at least one front node (step 110). The photographic unit of the at least one front node may be a camera, a video camera, a webcam, an image sensor or any other device for photographic.

In step 140, the at least one middle node receives the at least one present image captured by the at least one front node, and in step 160, the at least one middle node filters the at least one present image to obtain at least one characteristic block of the at least one present image.

In some embodiments, in step 160, the at least one present image may further be filtered to obtain an image block with a human face, a human physical characteristic, human clothes or any other characteristic for identifying the category which the at least one present image belongs to. The image block can be taken as the at least one characteristic block of the at least one present image. In some other embodiments, in step 160, a background or an environmental image may further be filtered out from the at least one present image to be taken as the characteristic block of the at least one present image. In other embodiments, the at least one characteristic block of the at least one present image can be obtained by other image processing methods. It should not be limited in this disclosure.

In step 180, the at least one middle node transmits the at least one characteristic block of the at least one present image to at least one end node. The at least one end node stores several candidate multimedia contents. In addition, since the at least one characteristic block of the at least one present image is filtered from the at least one present image, size of the at least one characteristic block of the at least one present image is smaller than size of the at least one present image. Hence, bandwidth for transmitting the at least one characteristic block of the at least one present image to the at least one end node is smaller than bandwidth for transmitting the at least one present image. In other words, bandwidth can be saved by transmitting the at least one characteristic block of the at least one present image instead of the at least one present image.

In step 190, the at least one end node selects at least one multimedia content proposed to be displayed, which is corresponding to the characteristic block of the at least one present image, from the candidate multimedia contents. In one embodiment of this invention, the candidate multimedia contents stored in the at least one end node may be further classified into several multimedia categories, and each of the candidate multimedia contents can be corresponding to one or several multimedia categories in step 190. For example, a characteristic in the characteristic block of the at least one present image, such as a human face, human physical characteristics or clothes worn on pedestrians passing through the at least one front node, can be identified, and the corresponding multimedia category corresponding to the characteristics is determined and the multimedia content proposed to be displayed is selected form the corresponding multimedia category. For instance, if a pedestrian in the characteristic block of the at least one present image is identified as an office clerk, the multimedia content, which corresponds to the category interesting office clerks, may be selected as the at least one multimedia content proposed to be displayed.

In step 200, the at least one middle node responds the at least one multimedia content proposed to be displayed to the at least one front node.

In step 210, the display unit of the at least one front node displays the at least one multimedia content proposed to be displayed. Therefore, the front node can display the multimedia content corresponding to the present image captured by the front node. In one embodiment, the multimedia content displayed on the display unit of the at least one front node may correspond to the category in the present image captured by the front node. Especially, if the multimedia content displayed on the display unit of the at least one front node is advertisement, the multimedia content displayed by the at least one front node may have better advertising effects. In addition, since the ability to identify the category of passengers passing through the at least one front node in the present image is not necessary for the middle node, the middle node does not have to equip with high performance hardware. In other words, a cheaper machine can be utilized as the middle node, which can save the cost to apply for the method for displaying multimedia content 100.

In some other embodiments, when step 200 responds the at least one multimedia content proposed to be displayed to the at least one front node, the multimedia content proposed to be displayed may be further stored in the middle node to be utilized for transmitting the same multimedia content in the future. Hence, the method for displaying multimedia content 100 may further include the following steps: in step 170, determine if the at least one middle node stores the at least one multimedia content proposed to be displayed. In step 190, if the at least one middle node does not store the at least one multimedia content proposed to be displayed, the at least one multimedia content proposed to be displayed is selected from the candidate multimedia contents stored in the end node. In step 220, if the at least one middle node does store the at least one multimedia content proposed to be displayed, the multimedia content proposed to be displayed, which is stored in the middle node, is responded to the at least one front node by the at least one middle node. Therefore, the bandwidth for transmitting the characteristic block of the at least one present image to the end node and for transmitting the multimedia content proposed to be displayed from the end node to the middle node may be further saved.

In addition, in some other embodiments of this invention, the number of the at least one front node is more than one, and the number of the at least one middle node is more than one. The front nodes and the middle nodes may be clustered to speed up the efficiency for executing the method for displaying multimedia content. Therefore, the method for displaying multimedia content 100 may further include the following steps: in step 120, each of the front nodes may capture an environmental image, which can be taken as a factor for clustering the front nodes capturing the environmental image thereof, respectively. In step 130, the present images, which are captured by the front nodes with similar environmental images, may be transmitted to the same middle node. Therefore, further in step 160, the same middle node may filter the present images, which are captured by the front nodes with similar environmental images, to obtain the characteristic block of the at least one present images. Since the environmental images captured by the front nodes, which transmit the present images to the same middle node, are similar, the middle node can filter for obtaining the characteristic block of the at least one present images easier. For example, the environmental images captured by the front nodes, which are disposed at different bus stops, may include image blocks with similar bus stops. Therefore, the middle node can filter for obtaining the characteristic block of the at least one present images by removing the image blocks with the bus stops from the present images.

Besides, in some other embodiments, to balance loadings of the middle nodes, the method for displaying multimedia content 100 may further include the following steps:

In step 150, after the present image is received, the middle node determines if the middle node, which receives the present image, is over-loaded. Wherein, the determination that if the middle node, which receives the present image, is over-loaded can be made according to CPU loading of the middle node, memory loading of the middle node, connection number to the middle node, combination thereof or any other loading related factor.

If in step 150 the middle node, which receives the present image, is not over-loaded, step 160 may be executed to make the middle node, which receives the present image, filter to obtain the characteristic block of the at least one present image. If in step 150 the middle node, which receives the present image, is over-loaded, step 230 may be executed to make the front node transmit the present image to another middle node, and then step 140 may be executed to make another middle node to receive the present image for filtering the received present image to obtain the characteristic block of the at least one present image. Therefore, loadings of the middle nodes can be balanced.

In some other embodiments, if the compression ratio of the size of the at least one characteristic block to the size of the at least one present image is not lower than a compression ratio threshold, the present image can be transmitted to another middle node for characteristic block of the at least one present image filtering. Hence, the method for displaying multimedia content 100 may further include the following steps: determine if the compression ratio of the size of the at least one characteristic block to the size of the at least one present image is over a compression ratio threshold by the at least one middle node. If the at least one middle node determines that the compression ratio is over the compression ratio threshold, the at least one present image is transmitted from the front node, which captures the at least one present image, to another middle node. Therefore, the size of the characteristic block of the at least one present image, filtered by another middle node, may be reduced, which saves the bandwidth to transmit the characteristic block of the at least one present image to the end node.

In some other embodiments, some middle nodes and some front nodes can be classified into a category, and the middle nodes and the front nodes in the same category transmit images to a same middle node to further filter the characteristic block of the at least one present images and the present images for data size reduction. Hence, the method for displaying multimedia content 100 may further include the following steps: the at least one front node and the at least one middle node, the environmental image captured by which or the characteristic block filtered by which are similar, are made to transmit the at least one present image and the characteristic block to the same middle node respectively for further filtering. Therefore, file size of the data can be further reduced before transmitting to the at least one end node.

In addition, in some other embodiments, in step 170, if the middle node does not store the at least one multimedia content proposed to be displayed, the method for displaying multimedia content 100 may further determine if other middle nodes store the at least one multimedia content proposed to be displayed. If at least one of the other middle nodes stores the at least one multimedia content proposed to be displayed, the at least one multimedia content proposed to be displayed can be obtained from the middle nodes storing thereof to respond to the at least one front node. Therefore, loading of the end node can be reduced. Besides, bandwidth needed for the end node can also be reduced.

If no other middle nodes store the at least one multimedia content proposed to be displayed, the at least one multimedia content proposed to be displayed is obtained from the at least one end node. Then, the at least one multimedia content proposed to be displayed is transmitted from the middle node, which obtains the at least one multimedia content proposed to be displayed, to the other middle nodes for storage utilizing peer-to-peer. Therefore, other middle nodes may store the at least one multimedia content proposed to be displayed to provide to the front nodes latter. In other words, the same multimedia content proposed to be displayed does not have to be obtained from the end node repeatedly.

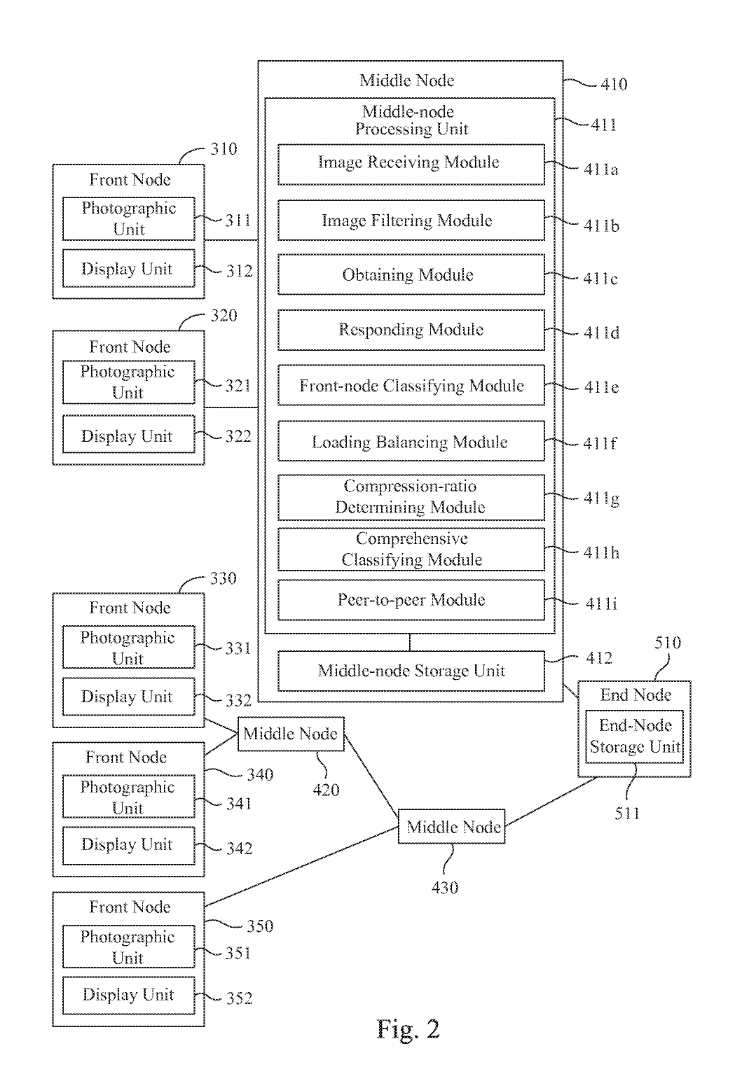

FIG. 2 illustrates a block diagram of a multimedia system according to another embodiment of this invention. In the multimedia system, an image captured by a front node is transmitted to a middle node. The middle node filters the received image to obtain at least one characteristic block of the image, and the at least one characteristic block of the image is provided to an end node for selecting a multimedia content to be responded.

The multimedia system mainly includes at least one front node 310, at least one end node 510 and at least one middle node 410. The at least one middle node 410 builds connections with the at least one front node 310 and the at least one end node 510 through a network respectively. The at least one front node 310 includes a photographic unit 311 and a display unit 312. The at least one end node 510 includes an end-node storage unit 511 for storing several candidate multimedia contents.

The at least one middle node 410 includes a middle-node processing unit 411. The middle-node processing unit 411 includes an image receiving module 411a, an image filtering module 411b, an obtaining module 411c and a responding module 411d. The image receiving module 411a receives at least one present image, which is captured by the photographic unit 311, from the at least one front node 310. The image filtering module 411b filters the at least one present image to obtain at least one characteristic block of the at least one present image. The image filtering module 411b may filter the at least one present image to obtain an image block with a human face, a human physical characteristic, human clothes or any other characteristic for identifying the category which the at least one present image belongs to. The image block can be taken as the at least one characteristic block of the at least one present image. In some other embodiments, the image filtering module 411 b may filter out a background or an environmental image from the at least one present image to obtain the characteristic block of the at least one present image. In other embodiments, the at least one characteristic block of the at least one present image can be obtained by other image processing methods. It should not be limited in this disclosure.

The obtaining module 411 c transmits the at least one characteristic block of the at least one present image to the at least one end node 510 to obtain at least one multimedia content proposed to be displayed, which is corresponding to the characteristic block of the at least one present image and is selected from the candidate multimedia contents, from the at least one end node 510. Since the at least one characteristic block of the at least one present image is filtered from the at least one present image, size of the at least one characteristic block of the at least one present image is smaller than size of the at least one present image. Hence, bandwidth for the middle node 410 to transmit the at least one characteristic block of the at least one present image to the at least one end node 510 is smaller than bandwidth to transmit the at least one present image. In other words, bandwidth can be saved by transmitting the at least one present image instead of the at least one present image.

In another embodiment of this invention, the candidate multimedia contents stored in the end-node storage unit 511 may be further classified into several multimedia categories, and each of the candidate multimedia contents can be corresponding to one or several multimedia categories. For example, the end node 510 may identify a characteristic in the characteristic block of the at least one present image, such as a human face, human physical characteristics or clothes worn on pedestrians passing through the at least one front node, and determine the corresponding multimedia category corresponding to the characteristics and select the multimedia content proposed to be displayed from the corresponding multimedia category. For instance, if the end node 510 identifies a pedestrian in the characteristic block of the at least one present image as an office clerk, the multimedia content, which corresponds to the category interesting office clerks, may be selected as the at least one multimedia content proposed to be displayed.

The responding module 411d responds the at least one multimedia content proposed to be displayed to the at least one front node 310. The display unit 312 of the front node 310 displays the at least one multimedia content proposed to be displayed. Therefore, the front node 310 can display the multimedia content corresponding to the present image captured by the front node. In one embodiment, the multimedia content displayed on the display unit of the at least one front node may correspond to the category in the present image captured by the front node 310. Especially, if the multimedia content displayed on the display unit 312 of the front node 310 is advertisement, the multimedia content displayed by the front node 310 may have better advertising effects. In addition, since the ability to identify the category in the present image is not necessary for the middle node 410, the middle node 410 does not have to equip with high performance hardware. In other words, a cheaper machine can be utilized as the middle node 410, which can save the cost of the multimedia system.

In some other embodiments, the middle node 410 may store the multimedia content proposed to be displayed to be utilized for transmitting the same multimedia content in the future. Hence, the middle node 410 may further include a middle-node storage unit 412, which is electrically connected to the middle-node processing unit 411. Hence, the obtaining module 411c may further determine if the middle-node storage unit 412 stores the at least one multimedia content proposed to be displayed. If the middle-node storage unit 412 stores the at least one multimedia content proposed to be displayed, the responding module 411d responds the at least one multimedia content proposed to be displayed stored in the middle-node storage unit 412 to the front node 310. Therefore, the bandwidth to transmit the characteristic block of the at least one present image to the end node 510 and transmit the multimedia content proposed to be displayed from the end node 510 to the middle node 410 may be further saved.

In addition, the multimedia system may further include another front node 320 and another node 420. Wherein, the middle node 420 may be equipped similarly to the middle node 410. Then, the front nodes 310, 320 and the middle nodes 410, 420 may be clustered to speed up efficiency of the multimedia system. Therefore, the middle-node processing unit 411 may further include a front-node classifying module 411e. The front-node classifying module 411e makes the photographic units 311, 312 of the front nodes 310, 320 capture an environmental image respectively. The front-node classifying module 411e makes the front nodes 310, 320 transmit the present images, which are captured by the front nodes with similar environmental images, to the same middle node. For example, if the environmental images captured by the front nodes 310, 320 are determined similar, the front nodes 310, 320 may be assigned to the same middle node 410, such that the front nodes 310, 320 transmit the present images captured to the middle node 410 for filtering. Since the environmental images captured by the front nodes 310, 320, which transmit the present images to the same middle node 410, are similar, the middle node 410 can filter to obtain the characteristic block of the at least one present images easier. For example, the environmental images captured by the front nodes 310, 320, which are disposed at different bus stops, may include image blocks with similar bus stops. Therefore, the middle node 410 can filter the present images captured by different front nodes 310, 320 to obtain the characteristic block of the at least one present images by removing the image blocks with the bus stops from the present images. In other embodiments, the front-node classifying module 411 e may be installed on other middle nodes 420, 430, end node 510 or any other machine, which should not be limited in this disclosure.

In another embodiment of this invention, the multimedia system may balance loadings of the middle nodes 410, 420. Therefore, the middle node 410 may include a loading balancing module 411f. The loading balancing module 411f determines if the middle node 410, where the loading balancing module 411f is disposed, is over-loaded. If the middle node 410, where the loading balancing module 411f is disposed, is over-loaded, the loading balancing module 411f makes the front nodes 310, 320 transmit the present images captured to another middle node. For example, when the middle node 410 is over-loaded, the loading balancing module 411f may make the front nodes 310, 320 transmit the present images captured to another middle node 420 for filtering. Wherein, the loading balancing module 411f may determine according to CPU loading of the middle node 410, memory loading of the middle node 410, connection number to the middle node 410, combination thereof or any other loading related factor of the middle node 410.

In another embodiment of this invention, if the compression ratio of the size of the at least one characteristic block to the size of the at least one present image is not lower than a compression ratio threshold, the present image can be transmitted to another middle node for characteristic block of the at least one present image filtering. Hence, the middle-node processing unit 411 may further include a compression-ratio determining module 411g. The compression-ratio determining module 411 g determines if the compression ratio of the size of the at least one characteristic block to the size of the at least one present image is over a compression ratio threshold. If the compression-ratio determining module 411g determines that the compression ratio is over the compression ratio threshold, the front node (310 or 320), which captures the present image thereof, transmit the present image captured to another middle node (such as 420). Therefore, the size of the characteristic block of the at least one present image, filtered by another middle node utilizing different filtering method, may be reduced, which saves the bandwidth to transmit the characteristic block of the at least one present image to the end node 510.

In another embodiment of this invention, some middle nodes and some front nodes can be classified into a category, and the middle nodes and the front nodes in the same category transmit images to a same middle node to further filter the characteristic block of the at least one present images and the present images for data size reduction. Hence, the middle-node processing unit 411 may further include a comprehensive classifying module 411h, and the multimedia system may further include more front nodes 330, 340, 350 and more middle node 430. The comprehensive classifying module 411h makes the photographic units 311, 321, 331, 341, 351 of the front nodes 310, 320, 330, 340, 350 capture environmental images respectively. The comprehensive classifying module 411 h makes at least one of the front nodes 310, 320, 330, 340, 350 and at least one of the middle nodes 410, 420, 430, the environmental image captured by which or the characteristic block filtered by which are similar, transmit the at least one present image and the characteristic block to the same middle node respectively.

In one embodiment of this invention, if the environmental image captured by the front node 350 is similar to the characteristic block of the at least one present image filtered by the middle node 420, the comprehensive classifying module 411h may make the present image captured by the front node 350 and the characteristic block of the at least one present image filtered by the middle node 420 be transmitted to the same middle node 430. Then, the middle node 430 can filter to obtain another characteristic block of the at least one present image from the received present image or characteristic block of the at least one present image to reduce the file size of the filtered characteristic block of the at least one present image. In other embodiments, the comprehensive classifying module 411h may be installed in other middle nodes 420, 430, end node 510 or any other machine, which should not be limited in this disclosure.

In addition, if the middle-node storage unit 412 of the middle node 410 does not store the at least one multimedia content proposed to be displayed, the multimedia system may further determine if any other middle node 420, 430 store the multimedia content proposed to be displayed. Hence, the obtaining module 411c may determine if the middle-node storage unit 412 stores the multimedia content proposed to be displayed. If the middle-node storage unit 412 does not store the multimedia content proposed to be displayed, the middle-node processing unit 411 determines if any other middle nodes 420, 430 stores the multimedia content proposed to be displayed. If at least one of the middle nodes 420, 430 stores the at least one multimedia content proposed to be displayed, the obtaining module 411c obtains the at least one multimedia content proposed to be displayed from the middle nodes storing thereof (420 or 430) to respond to the at least one front node 310. Therefore, loading of the end node 510 can be reduced. Besides, bandwidth needed for the end node 510 can also be reduced.

In another embodiment of this invention, if no other middle nodes store the at least one multimedia content proposed to be displayed, a peer-to-peer module 411i of the middle-node processing unit 411 obtains the at least one multimedia content proposed to be displayed from the at least one end node 510. Then, the peer-to-peer module 411i transmits the at least one multimedia content proposed to be displayed to the other middle nodes 420, 430 utilizing peer-to-peer. Therefore, other middle nodes 420, 430 may store the at least one multimedia content proposed to be displayed to provide to the front nodes latter. In other words, the same multimedia content proposed to be displayed does not have to be obtained from the end node 510 repeatedly.

Above all, the front node can display the multimedia content corresponding to the present image captured itself. In one embodiment, the multimedia content displayed on the display unit of the front node may correspond to the pedestrian category in the present image captured by the front node. Especially, if the multimedia content displayed on the display unit of the at least one front node is advertisement, the at least one front node may have better advertising effects. The middle node filters the captured image to obtain a characteristic block and only transmits the characteristic block to the end node, which can reduce the size of the transmitted image and reduce the loading of the end node. In addition, since the ability to identify the category in the present image is not necessary for the middle node, the middle node does not have to have better computing ability and hence cost of such middle node is much cheaper than the end node. In other words, a cheaper machine can be utilized as the middle node, which can save the cost.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for displaying multimedia content comprising:
capturing at least one present image by at least one front node, wherein the front node comprises a photographic unit and a display unit;
receiving the at least one present image utilizing at least one middle node, and filtering the at least one present image to obtain at least one characteristic block of the at least one present image;
transmitting the at least one characteristic block from the at least one middle node to at least one end node, wherein the at least one end node stores a plurality of candidate multimedia contents;
selecting at least one multimedia content proposed to be displayed, which is corresponding to the characteristic block of the at least one present image, from the candidate multimedia contents by the at least one end node;
responding the at least one multimedia content proposed to be displayed to the at least one front node passing through the at least one middle node; and
displaying the at least one multimedia content proposed to be displayed on the display unit of the at least one front node.

2. The method for displaying multimedia content of claim 1, wherein the step of responding the at least one multimedia content proposed to be displayed to the at least one front node passing through the at least one middle node comprising:
determining if the at least one middle node stores the at least one multimedia content proposed to be displayed; and
if the at least one middle node stores the at least one multimedia content proposed to be displayed, responding the at least one multimedia content proposed to be displayed, which is stored in the at least one middle node, to the at least one front node by the at least one middle node.

3. The method for displaying multimedia content of claim 1, wherein the number of the at least one front node is more than one and the method for displaying multimedia content further comprises:
capturing an environmental image by each of the front nodes respectively; and
transmitting the present images, which are captured by the front nodes with similar environmental images, to the same middle node.

4. The method for displaying multimedia content of claim 3 further comprising:
determining if the same middle node, which receives the at least one present image, is over-loaded by the at least one middle node; and
if the at least one middle node determines that the middle node, which receives the at least one present image, is over-loaded, transmitting the at least one present image from the at least one front node to another middle node.

5. The method for displaying multimedia content of claim 3 further comprising:
determining if the compression ratio of the size of the at least one characteristic block to the size of the at least one present image is over a compression ratio threshold by the at least one middle node; and
if the at least one middle node determines that the compression ratio is over the compression ratio threshold, transmitting the at least one present image from the front node, which captures the at least one present image, to another middle node.

6. The method for displaying multimedia content of claim 1, wherein the number of the at least one front node is more than one, the number of the at least one middle node is more than one, the method for displaying multimedia content further comprises:
capturing an environmental image by each of the front nodes respectively; and
making the at least one front node and the at least one middle node, the environmental image captured by which or the characteristic block filtered by which are similar, transmit the at least one present image and the characteristic block to the same middle node respectively.

7. The method for displaying multimedia content of claim 1, wherein the number of the at least one front node is more than one, the number of the at least one middle node is more than one, and the step of responding the at least one multimedia content proposed to be displayed to the at least one front node through the at least one middle node comprises:
determining if the middle node, which receives the present image, stores the at least one multimedia content proposed to be displayed; and
if the middle node, which receives the present image, does not store the at least one multimedia content proposed to be displayed, determining if any other middle node stores the at least one multimedia content proposed to be displayed; and
if at least one of the other middle nodes stores the at least one multimedia content proposed to be displayed, obtaining the at least one multimedia content proposed to be displayed from the other middle nodes storing thereof to respond to the at least one front node.

8. The method for displaying multimedia content of claim 7, wherein the step of responding the at least one multimedia content proposed to be displayed to the at least one front node through the at least one middle node further comprises:
if no other middle nodes store the at least one multimedia content proposed to be displayed, obtaining the at least one multimedia content proposed to be displayed from the at least one end node; and
transmitting the at least one multimedia content proposed to be displayed from the middle node, which obtains the at least one multimedia content proposed to be displayed, to the other middle nodes utilizing peer-to-peer.

9. A computer readable storage medium with a computer program to execute a method for displaying multimedia content, wherein the method for displaying multimedia content comprises:
capturing at least one present image by at least one front node, wherein the front node comprises a photographic unit and a display unit;
receiving the at least one present image utilizing at least one middle node, and filtering the at least one present image to obtain at least one characteristic block of the at least one present image;
transmitting the at least one characteristic block of the at least one present image from the at least one middle node to at least one end node, wherein the at least one end node stores a plurality of candidate multimedia contents;
selecting at least one multimedia content proposed to be displayed, which is corresponding to the characteristic block of the at least one present image, from the candidate multimedia contents by the at least one end node;
responding the at least one multimedia content proposed to be displayed to the at least one front node passing through the at least one middle node; and
displaying the at least one multimedia content proposed to be displayed on the display unit of the at least one front node.

10. A multimedia system comprising:
at least one front node comprising:
a photographic unit; and
a display unit;
at least one end node comprising:
an end-node storage unit for storing a plurality of candidate multimedia contents; and
at least one middle node building connections with the at least one front node and the at least one end node, wherein the at least one middle node comprises:
a middle-node processing unit comprising:
an image receiving module for receiving at least one present image, which is captured by the photographic unit, from the at least one front node;
an image filtering module for filtering the at least one present image to obtain at least one characteristic block of the at least one present image;
an obtaining module for transmitting the at least one characteristic block of the at least one present image to the at least one end node to obtain at least one multimedia content proposed to be displayed, which is corresponding to the characteristic block of the at least one present image and is selected from the candidate multimedia contents, from the at least one end node; and
a responding module for responding the at least one multimedia content proposed to be displayed to the at least one front node passing through the at least one middle node, such that the display unit of the at least one front node displays the at least one multimedia content proposed to be displayed.

11. The multimedia system of claim 10, wherein the at least one middle node further comprises:
a middle-node storage unit electrically connected to the middle-node processing unit, wherein the obtaining module further determines if the middle-node storage unit stores the at least one multimedia content proposed to be displayed,
wherein if the middle-node storage unit does store the at least one multimedia content proposed to be displayed, the responding module responds the at least one multimedia content proposed to be displayed stored in the middle-node storage unit to the at least one front node.

12. The multimedia system of claim 10, wherein the number of the at least one front node is more than one, the number of the at least one middle node is more than one, wherein the middle-node processing unit of each of the middle node further comprises:
a front-node classifying module for making the photographic unit of each of the front nodes capture an environmental image respectively, and making the front nodes transmit the present images, which are captured by the front nodes with similar environmental images, to the same middle node.

13. The multimedia system of claim 12, wherein the middle-node processing unit of each of the middle node further comprises:
a loading balancing module for determining if the middle node, where the loading balancing module is disposed, is over-loaded,
wherein if the middle node, where the loading balancing module is disposed, is over-loaded, the at least one present image is transmitted from the at least one front node to another middle node.

14. The multimedia system of claim 12, wherein the middle-node processing unit of each of the middle node further comprises:
a compression-ratio determining module for determining if the compression ratio of the size of the at least one characteristic block to the size of the at least one present image is over a compression ratio threshold,
wherein if the compression-ratio determining module determines that the compression ratio is over the compression ratio threshold, the at least one present image is transmitted from the front node, which captures the at least one present image, to another middle node.

15. The multimedia system of claim 10, wherein the number of the at least one front node is more than one, the number of the at least one middle node is more than one, wherein the middle-node processing unit of each of the middle node further comprises:
a comprehensive classifying module for making the photographic unit of each of the front nodes capture an environmental image respectively, and for making the at least one front node and the at least one middle node, the environmental image captured by which or the characteristic block filtered by which are similar, transmit the at least one present image and the characteristic block to the same middle node respectively.

16. The multimedia system of claim 10, wherein the number of the at least one front node is more than one, the number of the at least one middle node is more than one, wherein each of the middle nodes further comprises:
a middle-node storage unit electrically connected to the middle-node processing unit,
wherein the obtaining module determines if the middle-node storage unit stores the multimedia content proposed to be displayed,
if the middle-node storage unit does not store the at least one multimedia content proposed to be displayed, the middle-node processing unit determines if any other middle node stores the multimedia content proposed to be displayed,
if at least one of the middle nodes stores the at least one multimedia content proposed to be displayed, the obtaining module obtains the at least one multimedia content proposed to be displayed from the middle nodes storing thereof to respond to the at least one front node.

17. The multimedia system of claim 16, wherein the middle-node processing unit of each of the middle nodes further comprises:
a peer-to-peer module for obtaining the at least one multimedia content proposed to be displayed from the at least one end node and transmitting the at least one multimedia content proposed to be displayed to the other middle nodes utilizing peer-to-peer if no other middle nodes store the at least one multimedia content proposed to be displayed.
